(19) United States
(12) Patent Application Publication
(10) Pub. No.: US 2002/0150377 A1
(43) Pub. Date: Oct. 17, 2002

(54) Method for attenuation of optical signals using reflective membrane device

(76) Inventor: Daniel Gelbart, British Columbia (CA)

Correspondence Address: Dan Gelbart, Creo Products Inc., 3700 Gilmore Way, Burnaby, BC, V5G 4M1, CA

(21) Appl. No.: 09/832,935

(22) Filed: Apr. 12, 2001

(51) Int. Cl. G02B 6/26

(52) U.S. Cl. 385/140; 385/39

(57) ABSTRACT

An array of integrated micro-electromechanical stretched membrane reflecting devices are independently addressed and controlled to produce independently controlled degrees of attenuation in optical signals.

### CROSS-REFERENCES TO RELATED APPLICATIONS

“Method for linearization of an actuator via force gradient modification”, U.S. application Ser. No. 09/813839, filed Mar. 22, 2001.

### STATEMENT REGARDING FEDERALLY SPONSORED R&D

Not applicable

### REFERENCE TO MICROFICHE APPENDIX

Not applicable

### FIELD OF THE INVENTION

The invention pertains to the processing of signals and in particular to the controlled attenuation of optical signals.

### BACKGROUND OF THE INVENTION

The field of communications has benefited enormously from the introduction of optical communications technology. Fundamentally, this technology exploits the inherent bandwidth potential of the light itself as a carrier. As this technology matures, the need for the direct optical processing of the signals is becoming greater. Much of the communications infrastructure in operation in the field relies on signals being converted back to electrical for much of the processing and management. Direct optical processing has the benefit of avoiding the need for such conversion equipment with its associated costs, losses and amplification requirements.

One of the fundamental building blocks of an optical communications system is the variable attenuator. These devices are often used in parallel on a number of optical communications channels to ensure that signals are leveled. While various optical attenuators adequately provide slowly variable attenuation, there remains a substantial problem in the area of attenuation for signal leveling which can be changed rapidly.

The situation is exacerbated when many optical signal channels on parallel fibers have to be attenuated or adjusted at a single point in a communication system. This drives the need for a microelectronic device with a considerable level of device integration and individually adjustable channels. Simultaneously there is a clear need for devices that will perform this function whilst being rapidly adjustable in operation. Candidate devices are expected to have low insertion losses and the lowest possible wavelength dependence.

Micro-electromechanical (MEMS) devices have been applied in the field of optical modulation and attenuation before. MEMS devices are more typically employed as two state devices for binary functions, this being due to the difficulty in obtaining controlled analog deformation from the cantilever structures typically employed in these devices. Attenuators aimed at the low-attenuation end of the range are therefore typically difficult to fabricate using typical cantilever MEMS devices. Light modulating devices employing ribbon structures fabricated using micromachining have been described to address some of these problems. While the ribbon structures provide rapid response times, they do not adequately address the low attenuation end of the range as they are optimized for high contrast (that is, strong attenuation). In this respect it should be borne in mind that the user of an attenuator would in general prefer to maintain the full dynamic range of attenuation while simultaneously demanding good control at the low attenuation end of the range.

Another semiconductor technology approach is to employ a membrane that is fixed at its perimeter, or that extends over a system of holes, and to then deform one or more of these membranes using an electric field for electrostatic attraction. The typical device fabricated in this way operates by employing very tiny deformations and the principle of optical interference in order to obtain relative extinction of a beam. Along with these general principles of operation, comes a general tendency of these devices to be inherently wavelength-sensitive. Since optical fibers carry a plurality of wavelengths, an interferometric device is not preferable.

It is an object of the present invention to present a method by which a wide range of optical attenuation may be produced with good accuracy and reproducibility in a multi-channel device with a high degree of device integration.

Another object of the present invention is to ensure optical signal attenuation with a reproducible zero-voltage state and very low insertion losses.

Yet a further object of the present invention is to obtain attenuation that is both rapidly adjustable and wavelength independent.

### BRIEF SUMMARY OF THE INVENTION

In accordance with the present invention an array of integrated micro-electromechanical stretched membrane reflecting devices are independently addressed and controlled to produce independently controlled degrees of attenuation in optical signals.

### BRIEF DESCRIPTION OF THE DRAWINGS

FIG. 1 shows a microelectromechanical device in accordance with the present invention.

FIG. 2 shows a block diagram of the device in accordance with the present invention

### DETAILED DESCRIPTION OF THE PREFERRED EMBODIMENT

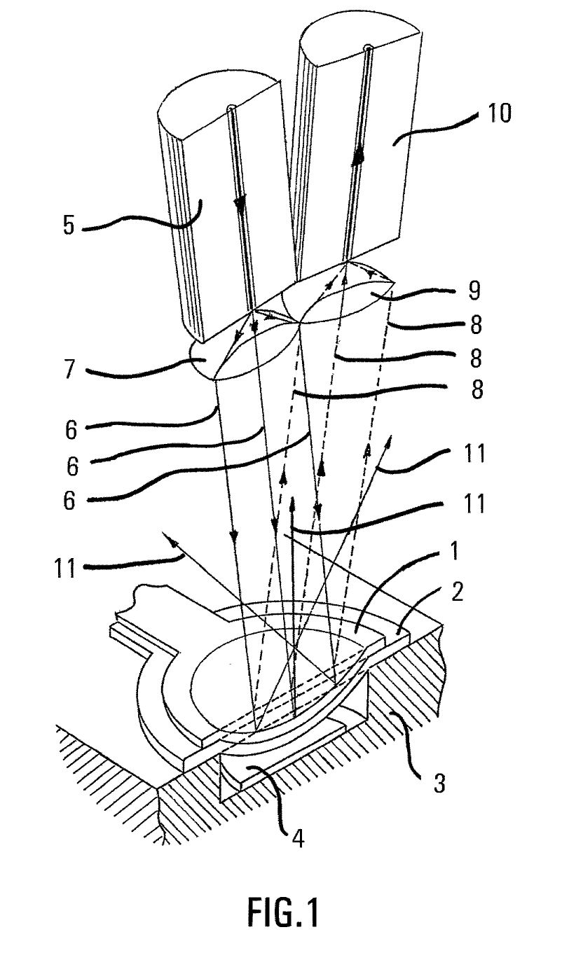

FIG. 1 illustrates the essence of the preferred embodiment of the present invention as a microelectromechanical (MEMS) optical attenuator. In practical application the complete device would have an array of elements of the type depicted here. For the sake of clarity, FIG. 1 shows a single element or channel.

Referring now to FIG. 1, optical reflector layer 1 is fashioned on top of flexible insulating layer 2. The two layers are fashioned over a circular “pillbox” cavity in silicon substrate 3 of the MEMS device. The section of the two layers that is suspended over the cavity in silicon substrate 3 constitute what we shall refer to in this application for letters patent as the reflective membrane of the attenuator. Silicon substrate 3 represents the fixed member of the preferred embodiment of the present invention.

Optical reflector layer 1 is composed of a reflective material and simultaneously serves as flexible electrode 1. In this preferred embodiment a metal is preferred and gold is selected for this purpose, but in the general case the material employed for the reflective function may be selected to suit the light being reflected. It is also possible to employ dielectric reflectors in the form of both single layer and multi-layers.

In the case of this preferred embodiment, flexible electrode 1 is also optical reflector layer 1 and the electrode and optical reflection functions are performed by the same layer. In the general case, the electrode layer and the reflective layer may be separated in order to optimize the reflectivity and electrode operation independently; for example, when dielectric reflectors are used, a separate layer is needed to conduct the electrical current and serve as electrode.

Flexible insulating layer 2 is fashioned on top of silicon substrate 3. The air space under flexible insulating layer 2 is created using a sacrificial layer micromachining process. Sacrificial layer techniques are well established in the microelectronics and microelectromechanical systems (MEMS) fields and will not be detailed herewith. Base electrode 4 is fashioned on top of silicon substrate 3 by standard microelectronic processes. By fashioning flexible insulating layer 2 from an insulating material such as silicon nitride, flexible insulating layer 2 ensures electrical isolation between electrode 1 and base electrode 4. The flexible membrane is therefore attached along its perimeter to the fixed member, silicon substrate 3, along its perimeter. It is to be noted that the perimeter referred to here is that of the flexible membrane, that is, the section of layers 1 and 2 that are suspended over the cavity in silicon substrate 3.

There are many variations on the processes for fabricating the attenuator described in this preferred embodiment and variations upon it. In one variation most of the layers from which the electrodes and the layers of the reflective membrane are fashioned consist of polysilicon of various doping and growth conditions, with silicon nitride employed as insulating layers where required. A detailed description of a representative variant of this kind of processing of MEMS devices is given by Bifano et al in Optical engineering, Vol36 (5), pp. 1354-1360 (May 1997).

It is evident that these processes may be used to create alternative detailed embodiments of the current invention that allow fabrication by planar processing in which all devices are fashioned within deposited layers, rather than etching the silicon base 3 of FIG. 1.

With no voltage applied between electrodes 1 and 4, light beam 6, guided by input optical fiber 5 and collimated by lens 7, strikes the flat surface of the reflective membrane (shown, in its un-actuated state, by the dotted lines in FIG. 1) and reflects directly back as beam 8 into lens 9, which couples beam 8 into the output optical fiber 10. In this preferred embodiment light beam 6 constitutes a specific example of a generic input optical signal. In this preferred embodiment, the core of optical fiber 10 defines a specific case of a generic fixed optical aperture for the output optical signal of the device. In order to minimize any potential reflection-induced polarization effects, the two fibers 5 and 10 are placed mutually adjacent and as close as possible to perpendicular to the plane of the un-actuated flexible membrane surface. An optional aperture (not shown) may be positioned between the flexible membrane surface and lenses 7 and 9 to control stray light.

In FIG. 1, for the sake of clarity, light beam 6 is shown as collimated by lens 7. It should be noted that lens 7 is not required to exactly collimate light beam 6. The reflection method described here will function equally well for any situation where the combination of lenses 7 and 9 is chosen such that the reflected light beam 8 is maximally coupled into the core of optical fiber 10. Since this device functions as a single direction attenuator, lenses 7 and 9 therefore also do not have to be identical.

Application of a voltage difference between electrodes 1 and 4 causes an electrostatic attractive force between the two electrodes. This is a standard actuating technique employed in many MEMS devices. In the case of the preferred embodiment of the present invention, as shown in FIG. 1, this electrostatic attractive force results in the reflective membrane deforming substantially concavely in radially symmetrical fashion. This deformation is shown exaggerated in FIG. 1 for the sake of clarity. This causes light beam 6 to be reflected as light beam 11. Under these circumstances the reflective membrane effectively functions as a concave mirror, acquiring a distinct focal length (exaggerated in FIG. 1 for the sake of clarity) that becomes shorter with increasing applied voltage. As the voltage is increased, a decreasing amount of the reflected light is therefore coupled into fiber 10 by lens 9.

Again it should be noted that the deformation is not required to produce a perfect concave mirror in order for the device to function for its intended purpose. Any exactly repeatable deformation will suffice, as long as it is repeatable, since this determines the controllability of the device and its inherent performance, particularly at low levels of attenuation where the vast majority of light is to still make its way into the optical aperture represented by the core of fiber 10. Bifano et al, in FIG. 10 of Optical Engineering, Vol 36 (5), pp. 1354-1360 (May 1997), describe the variation of the membrane deformation with applied voltage and it is evident from that work that the deformed membrane lends itself to good control at low applied voltages, which correlate to small deformations and low attenuation.

It is well known to practitioners in the field that layers such as flexible insulating layer 2 and optical reflector layer 1 may be deposited with various degrees of pre-stress by an appropriate choice of micro-lithographic materials and processing conditions. In the preferred embodiment of the invention shown in FIG. 1 the flexible insulating layer 2 and electrode 1 are preferably deposited in tension.

The purpose of this pre-stressing step is to obtain a radially symmetrical stress-field in the reflective membrane. This pre-stressing ensures that the reflective membrane is as flat and mirror-like as possible when no voltage is applied between electrodes 1 and 4. This in turn ensures that, at zero induced attenuation, the device will pass the greatest possible percentage of incoming light through to the optical aperture (the core of optical fiber 10). This is an important requirement for attenuators that are to function at the low-end of the attenuation range. The pre-stressing also provides the device with better control over membrane displacement, particularly at low voltages and small displacements. It furthermore ensures a high natural resonance frequency, which allows the device to be employed in systems that require rapidly varying attenuation.

In the case of the present invention, the stressed circular reflective membrane has a distinctive and well-controllable elastic deformation. MEMS devices are well known to exhibit a so-called “snap-down” phenomenon. This occurs in cantilever devices where the voltage reaches a point at which the elastic restoring force of the cantilever is exceeded by the electrostatic attractive force and the cantilever physically snaps down onto the silicon substrate. The snap-down point is typically between 33% and 50% of the maximum travel of the actuator. This is a well-known effect and needs no further discussion here. The present invention, by virtue of the choice of circular membrane and pre-stressing, exhibits a deformation of the reflective membrane that is both radially symmetrical and much more controllable than cantilever devices. The choice of membrane materials, thickness and pre-stressing jointly determine the extent of depression of the center of the membrane for a given applied voltage. As with cantilever devices, the stressed circular reflective membrane of the present invention will also ultimately snap down if excessive voltage is applied between the electrodes. In this application for letters patent, the term “maximum travel” is used to describe the distance by which the center of flexible insulating layer 2 moves during deformation in order to touch the base electrode 4 when it is being deformed.

The elastic deformation of the reflective membrane is substantially concave with the detailed functional shape being determined by the diameter of the reflective membrane, the lateral extent of electrode 4, the elastic properties of the membrane and the size of the applied voltage. It is clear that relatively small deformations of the reflective membrane are adequate to obtain relatively large attenuation. The absolute extent of deformation employed in this invention, as indeed with most MEMS devices, is very small.

The particular choice of employing a pre-stressed circular reflective membrane addresses in particular the matter of the efficacy of the technique presented here in the case of applications requiring low degrees of attenuation. In such cases the deformation of the reflective membrane is extremely small and yet has to be controlled. Cantilever devices inherently deform or curl due to deposition-induced stresses. It is exceedingly difficult to produce cantilever devices that are totally flat at zero applied voltage. Similarly, it is very difficult to impose a repeatable degree of curl on such a cantilever device with a view to having a repeatable zero-voltage curl.

In the case of devices that have deforming surfaces that are strapped down around their perimeters, but in which the deforming surface is not pre-stressed, there is also difficulty in assuring a repeatable situation at zero applied voltage. In keeping with the objects of the present invention, the deformable membrane is radially stressed in order to ensure a reproducible zero-voltage state for the device.

Another object of the invention is to ensure that optimal control over the deformation is obtained, particularly at small deformations. With devices that are not pre-stressed, the deformable membrane can assume a variety of deformations under the action of the voltage and the attenuation will thereby be difficult to control. By pre-stressing the membrane, the device is effectively being biased towards maximal optical throughput at zero applied voltage.

The notion of employing a stressed membrane to obtain controlled deformations has found application in some unrelated fields, such as in microphones and pressure gauges. In the case of the former, the devices are comparatively large and do not relate to multi-channel optical signal processing. In both cases the deformations involved are rather large. Neither of these applications in any way leads to the application of a stressed reflective membrane to obtain the controlled attenuation of light beams with respect to a fixed optical aperture.

By way of example, a silicon nitride membrane with a diameter of 1 mm, a thickness of below one micron and an air gap of about 1.5 microns can be deflected about 1 micron with a voltage of below 100V. Such a membrane, when deflected, will form a mirror with a focal length of about 62 mm. The approximate formula for the focal length is given by:

f=(membrane diameter)²/(16×deflection).

When two fibers are coupled as shown in FIG. 1, with an optical path length of about 60 mm between the collimating lenses and using a molded aspheric glass lens as a collimator, the attenuation can be changed from below 1 dB to over 20 dB in a continuous and repeatable manner in a few microseconds. The aspheric lens is available from many sources, for example f=3.9 mm, part number 350080, from Geltech (Florida, USA).

FIG. 1 shows one attenuating element with an associated input optical fiber and an output optical fiber. This embodiment of the present invention may be repeated in two dimensions in a plane to create an array of attenuators. It is possible to fabricate all of these devices on a single contiguous section of silicon wafer using standard MEMS technology as described and referred to above. In this way it is therefore possible to generate one- or two-dimensional arrays of optical attenuators for managing signal levels in a multiplicity of optical channels.

The above embodiments share the same inventive method comprising the use of a reflective membrane, attached by its perimeter to a fixed frame, and actuated by electrostatic force to effect the controlled attenuation of an optical input signal transiting through the device.

In the more general case the perimeter of the membrane is not circular, but of any smoothly varying two-dimensional shape. This allows the membrane to be pre-stressed without inducing areas of excessive local stress, such as will occur at sharp corners.

It is evident from the preferred embodiment of the present invention, that, since pure reflection is employed with no reliance on any diffractive, refractive or interference-based aspects, the invention provides for a method of optical attenuation that is substantially independent of wavelength. The wavelength limitations involved pertain only to the choice of materials. This matter is in the hands of the designer of products embodying the invention and does not limit the invention itself in respect of wavelength.

No feedback is employed in the preferred embodiment of the present invention, as the addition of such a function adds to the complexity and cost of the device. This should be seen against the background of one of the objects of the invention being to obtain a low cost device. However, feedback can be incorporated in an alternative embodiment of the present invention by a number of different means. These include capacitively measuring the membrane position or sampling the light going in and coming out and adjusting the applied voltage and consequent deformation based on this measurement.

The actuation of the membrane may be linearized or given any desirable transfer function. The term linearization is used in this application for letters patent to describe any collection of steps or mechanisms that leads to the actuation behavior of the actuator being mathematically described by a set of linear differential equations. One way in which this may be achieved is by means of lookup tables relating the input actuation and output deformation of the membrane. A linearization look-up table can be included in a semiconductor memory structure, which may be incorporated on the same contiguous piece of silicon wafer as the attenuator itself. In a co-pending application for letters patent under the title “Method for linearization of an actuator via force gradient modification” (U.S. Ser. No. 09/813839, filed Mar. 22, 2001) this kind of mechanism is described in detail and is hereby incorporated in full.

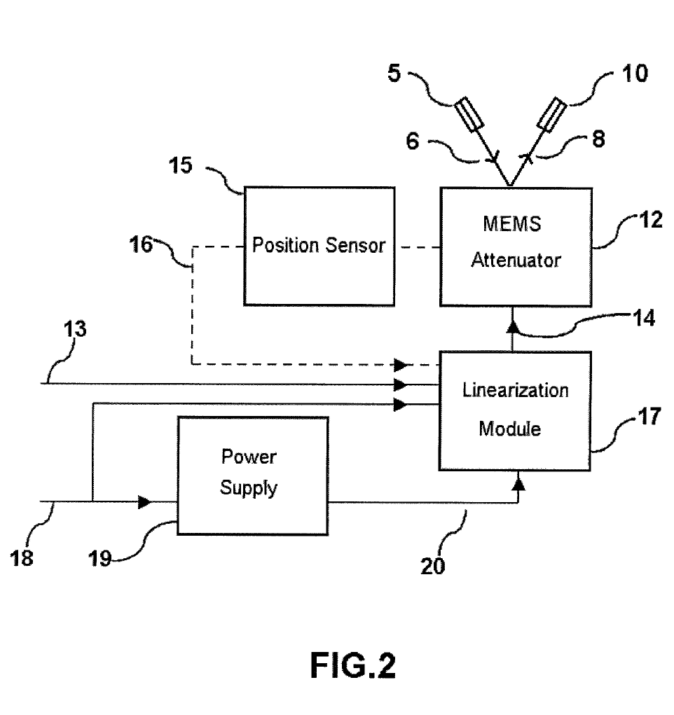

FIG. 2 shows such an alternative embodiment of the present invention in which the preferred embodiment, shown in FIG. 1, is incorporated as attenuator element 12, with the optical fibers 5 and 10 and the light beams 6 and 8 numbered as in FIG. 1. This attenuator 12 can also be controlled via control signal 13 which is adapted by linearization module 17 and provided to the attenuator 12 as actuation signal 14.The deformation of the membrane of attenuator 12 is sensed by position sensing means 15, which provides linearization module 17 with a feedback signal 16. Input power 18, typically 5 VDC, 12 VDC or 48 VDC, is provided to the whole system and power supply 19 uses this energy source to provide the linearization module 17, and thereby attenuator 12, with a higher voltage 20, which may typically be between 50 and 100 V. Linearization module 17 generates the actuation voltage 14, typically 0-100V. The linearization module can be of the analog type or, preferably, digital with a lookup-table and programmable with an arbitrary transfer function. Such methods are well known in the art. For greater long-term stability a position sensor 15 measures the actual position and/or performance of the attenuator and further modifies the actuation voltage 14 by a mechanism described in more detail below using FIG. 3.

In the present application for letters patent, we define the actuator characteristic of the device as the slope of the restoring force with respect to the displacement of the center of the membrane. For a simple linear spring model, this is equivalent to the spring constant. For the present invention, where a membrane is being deformed, the restoring force is substantially non-linear with displacement, particularly at larger displacements, and the actuator characteristic is a more complex function of displacement of the center of the membrane. This actuator characteristic is adjusted during the course of actuation in order to obtain maximal control over the actuation process, particularly at comparatively large deformations, where MEMS devices are characteristically prone to “snap-down”.

FIG. 3 shows one conceptual circuit implementation of the control elements in FIG. 2. In FIG. 3 the electrostatic force in a micromachined device changes as 1/x², where x is the air gap between oppositely charged, mutually attractive electrodes. For small air gaps, the rapid increase in attractive electrostatic force overcomes the restoring spring action of the deforming cantilever or flexible membrane employed in the device. This causes the well-known “snap-down” phenomenon, which limits the dynamic range of micro-machined electrostatic actuators. This is the reason for using most such actuators in a binary or on-off mode.

By incorporating into the disclosed attenuator a means to prevent snap-down, a much larger fraction of the total deformation range of the flexible membrane may be used. Since the disclosed invention modifies the relationship between voltage and displacement, and thereby attenuation, this modification can be further use to linearize the relationship or give it any other desired transfer relationship such as logarithmic or compressed.

There are numerous ways that may be employed to eliminate “snap-down”, or to delay it such that it occurs after much larger travel distances on the part of the deforming member, as compared with unmodified devices. The preferred embodiment shown in FIG. 3 employs active position feedback, thus controlling the position of the flexible membrane of FIG. 1, contained inside MEMS attenuator 12 of FIG. 3, in a closed-loop mode. The position sensing is performed using high frequency signal 21. The frequency of this signal is chosen to be well above the natural resonance frequency of the micromachined actuator in order to avoid modulation of the attenuated light.

The sensing may be performed using an auxiliary electrode or the same electrode as what is used for the deflection, i.e., flexible electrode 1 of FIG. 1. In the preferred embodiment high frequency signal 21, in the range of 1 MHz-100 MHz, is superimposed on the variable DC actuation voltage 14 employed for the deflection process. This superimposed signal can be used in a capacitive voltage divider or as part of an oscillator. In the case of the latter, the oscillator frequency is proportional to the position.

By way of example, the control signal 13 has a maximum frequency of 0.3 MHz, giving a rise time of approximately 1 microsecond, while high frequency source 22 is an oscillator operating at 100 MHz. High frequency source 22 can be one of many common designs, such as a single transistor RC phase shift oscillator. The exact frequency is not important as the ratio between the capacitance of reference capacitor 23, and the capacitance between flexible electrode 1 of FIG. 1 and base electrode 4 of FIG. 1 is being measured. This latter variable capacitance is represented by inter-electrode capacitance 24 in FIG. 3.

The resulting ac feedback signal is rectified by rectifier 25 and filtered by filter capacitor 26 and fed back to linearization module 17 as a feedback signal 16. Linearization unit 17 includes the necessary amplifier to produce adequately high voltage to actuate the MEMS attenuator 12. Only the simplest of control systems is disclosed here. More elaborate control systems are known in the art. Typical values for the inter-electrode capacitance 24 and the reference capacitor 23 are approximately 1 pF. Filter capacitor 26 is much larger. Inductor 27 has to be large enough to stop linearization module 17 from shorting the ac voltages in the circuit, but not so large that it will slow the actuation response of the attenuator. For a sensing frequency of 100 MHz a typical value for inductor 27 is 100 microHenry, and the value of filter capacitor 26 is chosen to give a time constant of about 0.1 microseconds.

The reason for the “snap-down” problem in electrostatically actuated MEMS membrane devices may be traced to the fact that the elastic restoring forces in the devices vary more slowly with displacement of the membrane than the electrostatic attractive force. It is well-known in the art that the actuation characteristic of an actuator may be modified either by means of feedback, as described thus far in the present invention, or by means of passive adaptation.

Two fundamental approaches are may be employed to implement passive adaptation. In the first case, the inherent elastic deformation properties of the attenuator may intentionally be made more non-linear in order to ensure that the restoring elastic force increases supra-linearly with displacement of the center of the membrane. In itself, the choice of a membrane restrained at its periphery, already represents such a choice in that the elastic deformation characteristics of such a structure are more non-linear than the more typical cantilever structures that abound in MEMS devices. This non-linearity may be further increased via a combination of structural design choices and engineering of the layer structure of the membrane.

In the second case the dynamic electrical properties of the attenuator may be passively adapted via an appropriate arrangement of passive electronic and electrical components around the electrostatically actuated capacitor comprising electrodes 1 and 4 of FIG. 1 in order to modify the circuit impedance experienced by the capacitor when the voltage across it rises.

There has thus been outlined the important features of the invention in order that it may be better understood, and in order that the present contribution to the art may be better appreciated. Those skilled in the art will appreciate that the conception on which this disclosure is based may readily be utilized as a basis for the design of other apparatus for carrying out the several purposes of the invention. It is most important, therefore, that this disclosure be regarded as including such equivalent apparatus as do not depart from the spirit and scope of the invention.

What is claimed is:

1. A method for attenuating an input optical signal to produce a corresponding output optical signal using a tensile stressed micromachined reflective membrane and a fixed optical aperture, said membrane being attached at its perimeter to a fixed member and said membrane having a maximum travel and an actuator characteristic, said method comprising controllably deforming said membrane to more than 60% of its maximum travel by modifying said actuator characteristic, to vary thereby the fraction of said input optical signal that is transmitted through said fixed optical aperture.

2. A method as in claim 1, wherein said deformation is induced by electrostatic force.

3. A method as in claim 1, wherein the perimeter of said membrane is substantially circular.

4. A method as in claim 1, wherein said input optical signals and said output optical signals are carried by optical fibers.

5. A method as in claim 1, wherein said membrane is one of a multiplicity of substantially identical membranes fabricated on one contiguous section of silicon wafer, said membrane being capable of being deformed independently of any other one of said multiplicity of membranes.

6. A method as in any of the above claims, wherein the extent of said attenuation is controlled via a feedback method.

7. A method as in claim 6, wherein said feedback method comprises the use of a signal indicative of the extent of one or more of said attenuation, said deformation, the electrostatic force between said membrane and an electrode on said fixed member, and the electrical capacitance between said membrane and said electrode.

8. A method as in claim 7, wherein said feedback method comprises linearization of said attenuator.

9. A method as in claim 8, wherein said linearization is achieved by the use of look-up tables.

10. A method as in claim 9, wherein said look-up tables are programmed into memory cells resident on the same piece of contiguous silicon as said attenuator.

11. A method as in claim 1, wherein said modifying is by passive adaptation of the elastic properties of said membrane.

12. A method as in claim 1, wherein said modifying is by means of passive adaptation of the electrical properties of said attenuator.

13. A variable optical attenuator for attenuating an input optical signal to produce an output optical signal, said attenuator comprising a tensile stressed micromachined reflecting membrane that is deformable to vary the fraction of said input optical signal that is transmitted through said fixed optical aperture, said membrane being attached at its perimeter to a fixed member and said membrane having a maximum travel and an actuator characteristic, said membrane being controllably deformed to more than 60% of its maximum travel by modifying said actuator characteristic.

14. A variable optical attenuator as in claim 13, wherein said deformation is induced by electrostatic force.

15. A variable optical attenuator as in claim 13, wherein said membrane is substantially circular.

16. An variable optical attenuator as in claim 13, wherein said membrane is one of a multiplicity of substantially identical membranes fabricated on one contiguous section of silicon wafer, said membrane being capable of being deformed independently of any other one of said multiplicity of membranes.

17. A method as in claim 13, wherein said modifying is by passive adaptation of the elastic properties of said membrane.

18. A method as in claim 13, wherein said modifying is by means of passive adaptation of the electrical properties of said attenuator.

19. A variable optical attenuator comprising a tensile stressed micromachined membrane attached at its perimeter to a fixed member, said membrane being capable of changing its curvature in response to an electrical control signal, the surface of said membrane functioning as a mirror coupling an input optical signal from a first optical fiber to a second optical fiber, said coupling being controlled by said curvature and said membrane controllably deforming to more than 60% of its maximum travel.

20. A variable optical attenuator as in claim 19, wherein said membrane is one of a multiplicity of substantially identical membranes fabricated on one contiguous section of silicon wafer, said membrane being capable of being deformed independently of any other one of said multiplicity of membranes.

21. A variable optical attenuator comprising a tensile stressed micromachined membrane attached at its perimeter to a fixed member, said membrane being capable of changing its curvature in response to an electrical control signal, the surface of said membrane functioning as a mirror coupling an input optical signal from a first optical fiber to a second optical fiber in a manner substantially independent of wavelength and said membrane deforming to more than 60% of its maximum travel while under control of said control signal.

22. A variable optical attenuator as in claim 21, wherein said membrane is one of a multiplicity of substantially identical membranes fabricated on one contiguous section of silicon wafer, said membrane being capable of being deformed independently of any other one of said multiplicity of membranes.

23. A variable optical attenuator for attenuating an input signal to produce an output optical signal, said attenuator comprising a tensile stressed micromachined reflecting membrane that is deformable to vary the fraction of said input optical signal that is transmitted through said fixed optical aperture, and said membrane having an actuator characteristic, said membrane being controllably deformed to more than 60% of its maximum travel and said actuator characteristic being modified during actuation.

24. A method as in any one of claim 19, 21, and 23, wherein said modifying is by passive adaptation of the elastic properties of said membrane.

25. A method as in any one of claim 19, 21, and 23 wherein said modifying is by means of passive adaptation of the electrical properties of said attenuator.

26. A variable optical attenuator as in any one of claim 13 or claim 19 or claim 21 or claim 23 wherein the extent of said attenuation is controlled via a feedback mechanism.

27. A variable optical attenuator as in claim 26 wherein said feedback mechanism comprises a feedback sensor indicating the extent of one or more of said attenuation, said deformation, the electrostatic force between said membrane and an electrode on said fixed member, and the electrical capacitance between said membrane and said electrode.

28. A variable optical attenuator as in claim 27 wherein said feedback mechanism comprises a linearization means to linearize said attenuator.

29. A variable optical attenuator as in claim 28 wherein said linearization means comprises look-up tables.

30. A variable optical attenuator as in claim 29 wherein said look-up tables are programmed into memory cells resident on the same piece of contiguous silicon as said attenuator.
